(19) United States
(12) Patent Application Publication
(10) Pub. No.: US 2025/0206609 A1
(43) Pub. Date: Jun. 26, 2025

(54) ISOTOPIC SEPARATION OF LITHIUM

(71) Applicant: Renaissance Fusion, FONTAINE (FR)

(72) Inventor: Francesco VOLPE, FONTAINE (FR)

(21) Appl. No.: 18/850,490

(22) PCT Filed: Apr. 4, 2023
(86) PCT No.: PCT/EP2023/058821

§ 371 Date: Sep. 24, 2024

(30) Foreign Application Priority Data
Apr. 4, 2022 (EP) 22305438.8
Apr. 4, 2022 (EP) 22305450.3

(51) Int. Cl. C01B 6/04

(52) U.S. Cl. CPC C01B 6/04; C01P 2006/88

(57) ABSTRACT

The present disclosure relates to a method for isotopic separation of lithium, the method comprising:—providing a first mixture (104) comprising at least lithium, lithium hydride, and possibly lithium deuteride and/or lithium tritide, the first mixture being at a first temperature;—a first cooling step (110), preferably a uniform cooling, adapted to cooling the first mixture at a second temperature lower than the first temperature; the first cooling step being adapted to precipitating a first part of the lithium hydride having a first lithium isotope;—a first separation step (124) adapted to separating the precipitated first part of the lithium hydride from the first mixture, forming a second mixture (122).

This application is based on and claims the priority benefit of European patent application number 22305449, filed on Apr. 4, 2022, entitled “ISOTOPIC SEPARATION OF LITHIUM”, and European patent application number 22305438, filed on Apr. 4, 2022, entitled “DEVICE AND METHOD FOR EXTRACTION OF LITHIUM HYDRIDES”, which are hereby incorporated by reference to the maximum extent allowable by law.

### TECHNICAL FIELD

A method for isotopic separation of lithium isotopes is disclosed herein. In particular, the disclosed method is directed to the separation of lithium isotopes in a fluid medium based on phase change temperature differences.

### BACKGROUND ART

The world has a need for the separation of isotopes, mostly the separation of the lighter isotopes from the elements. In nuclear power applications, including fusion and fission, there is a need to separate the isotopes of lithium that occur in nature, lithium-6 (⁶Li) and lithium-7 (⁷Li). Naturally occurring lithium contains 7,4% of ⁶Li and 92, 6% of ⁷Li.

In fusion for nuclear power generation, lithium is used to breed tritium, the primary fuel of a fusion power generator. Yet, the most commonly occurring isotope of lithium, ⁷Li, is a poor breeder of tritium due to its smaller cross section, so it is desirable to use ⁶Li for tritium breeding blankets. Because this isotope is much less common, enrichment of lithium is required. By enrichment, the concentration of ⁶Li in a sample increases. In solid breeders, the concentration may have to increase to between 30% and 60%; yet in liquid breeders, the concentration may have to go as high as 90%.

Lithium enrichment is useful in other applications. In power generators utilizing the principles of nuclear fission, ⁷Li at about 99% percent purity is used as a neutron absorber, to control the acidity, the neutron moderation and as a coolant in molten salt reactors.

The current demand for enriched lithium is increasing because Li-ion batteries work more efficiently with ⁶Li and is also expected to increase more in the following years, as fusion reactors become a reality.

Currently, enriched lithium is supplied by the stockpiles produced in the US between 1950 and 1970s using the expensive process known as COLEX. The market price for ⁶Li is at about 500 dollars per 10 g, when considering that the amount required for a fusion power plant per giga watt of energy is in the order of 60 tons, this cost is prohibitive.

Presently, there seems to be no method that can produce the amount of enriched lithium that fusion power plants would require. In addition to that, the methods that have been developed suffer from two issues: they are very expensive, and they are highly pollutant to the environment.

Enriched lithium has been produced mainly by three methods, COLEX, OREX and ELEX. COLEX and OREX are chemical exchange processes based on counter-current flow of a LiOH or LiCl solution and a lithium amalgam. The enriched lithium is deposited on the amalgam phase. Methods based on the electrical properties of lithium have also been used. In the ELEX method, a lithium salt solution is electrolyzed using a mercury cathode in a counter-current flow.

In particular, the methods mentioned utilize mercury in some capacity. Between the 1950s and 1980s, these methods were used extensively to produce lithium in the United States. The COLEX process alone used about 24 million pounds of mercury. Although most of that mercury was properly dispatched of, about 2 million pounds have not been accounted for. The unaccounted-for mercury may have found its way into the environment and may be the cause of mercury pollution of several water bodies in east Virginia.

Current trends in separation or enrichment of lithium ions involve laser separation and electromagnetic separation. These methods are expensive and slow, and they also require very specific materials and equipment. The limitations of these methods have been noted by Dr.-Ing. Thomas Giegerich the Lead engineer for DEMO vacuum system developments. Dr.-Ing. Thomas Giegerich wrote in “Lithium enrichment issues in the sustainable supply chain of future fusion reactors” available at www.kit.edu, that it is proposed to develop mercury based methods further as the classical COLEX related methods have the highest quality value at the lowest development effort.

In U.S. Pat. No. 8,672,138 to Raizen et al. a vapor having several atoms of a single element is formed into a stream and then light waves are applied. The light waves are tuned to prepare specific isotopes to certain magnetic states. Then a magnetic field is applied that separates the isotopes according to their magnetic states. The method described is clearly based on both laser and electromagnetic methods that exploit these properties of isotopes. Methods like the one described by Raizen are unsuitable for lithium applications. They are inadequate because lithium isotopes in a fusion reactor must be separated as part of the power plant process. Because the element must be vaporized it is not easy to integrate this method with a fusion reactor process, where lithium may be either liquid or solid. A mayor issue with Raizen's method is that the temperatures the fusion process works at may not allow for every part of the method to work. In addition, the method may be too slow to accommodate the pace required by the fusion reactor. Also, because of the light wave equipment required by the method, which may need very specific temperatures to work as well as expensive components, it is not a very suitable method for a fusion power plant to rely upon for lithium enrichment.

Another method based on lasers is described in U.S. Pat. No. 4,149,077 to Yamashita et al. The laser, according to Yamashita, separates lithium isotopes by irradiating a lithium atomic beam with a beam tuned to the absorption lines of either isotope of lithium. This results in the ionization of that isotope which is then separated by means of a mass-filter, for example a mass spectrometer based on magnetic fields. This method suffers from needing lithium to be in a very specific state in order to operate, in this case a lithium atomic beam. Using this method in a fusion power plant, requires that the working lithium be removed from the process, treated, and then reinserted. This may cause additional heat losses, which, depending on the plant configuration, may not be easy to overcome. Further, they process may need to be stopped to prepare the lithium and then effect the separation, so it is not a method that would work properly as part of a fusion power plant process.

Processes based on electromagnetic properties of the isotopes and laser methods are also very hard and costly to scale, as they are either surface effects, or volumetric effects on atom or ion beams, necessarily in the gas or plasma state, and thus typically of lower density than liquids and solids. These processes also have very low energy efficiency which adds to the overall cost of the process. Considering that it has been noted by experts in the field that the current trends are limited to chemical separation methods using mercury like and COLEX methods that exploit the electromagnetic properties of the lithium isotopes; there is a need for lithium isotope separation methods, that are reliable, inexpensive, fast, good to the environment and that may work in collaboration with a fusion reactor process.

### SUMMARY OF INVENTION

One embodiment addresses all or some of the drawbacks of known methods for isotopic separating of lithium.

One embodiment provides a method for isotopic separation of lithium, the method comprising:
providing a first mixture comprising at least lithium, lithium hydride, and possibly lithium deuteride and/or lithium tritide, the first mixture being at a first temperature;
a first cooling step, preferably a uniform cooling, adapted to cooling the first mixture to a second temperature lower than the first temperature; the first cooling step being adapted to precipitating a first part of the lithium hydride having a first lithium isotope;
a first separation step adapted to separating the precipitated first part of the lithium hydride from the first mixture, forming a second mixture.

In one embodiment, the method further comprises a first extraction step adapted to extracting the precipitated first part of the lithium hydride, after or during the first separation step.

In one embodiment, the method further comprises:
a second cooling step, preferably a uniform cooling, adapted to cooling the second mixture to a third temperature lower than the second temperature; the second cooling step being adapted to precipitate a second part of the lithium hydride having the second lithium isotope; and
a second separation step adapted to separating the precipitated second part of the lithium hydride from the second mixture, forming a third mixture.

In one embodiment, the method further comprises a second extraction step adapted to extracting the precipitated second part of the lithium hydride, after or during the second separation step.

In one embodiment, the first and/or the second cooling step is slow, for example has a cooling rate less than 1° C. per minute.

In one embodiment, providing the first mixture comprises a heating step adapted to heating the first mixture to the first temperature.

In one embodiment, the method comprises repeating the providing step and repeating:
the first cooling and separating steps, at least part of the second mixture being used as the first mixture; and/or
the second cooling and separating steps, at least part of the third mixture being used as the first mixture.

In one embodiment, the first isotope is the ⁷Li isotope and the second isotope is the ⁶Li isotope. In one embodiment:
the first temperature is above about 410° C., for example above about 500° C.;
the second temperature is comprised between 390° C. and 410° C., for example equal to about 400° C.; and/or
the third temperature is comprised between 388° C. and 408° C., for example equal to about 398° C.

In one embodiment, at least one of the first and second separating steps comprises spinning the first and/or the second mixture, for example spinning a chamber containing said mixture.

One embodiment provides a method for isotopic separation of lithium, the method comprising:
providing a first mixture comprising at least lithium, lithium hydride, the first mixture being at a first temperature;
a first cooling step, preferably a uniform cooling, adapted to cooling the first mixture to a second temperature lower than the first temperature; the first cooling step being adapted to precipitating a first part of the lithium hydride having a first lithium isotope;
a first separation step adapted to separating the precipitated first part of the lithium hydride from the first mixture, forming a second mixture; and
a first extraction step adapted to extracting the separated first part of the lithium hydride, after or during the first separation step.

In one embodiment, the first mixture further comprises lithium deuteride and/or lithium tritide.

In one embodiment, the first cooling step is slow, for example has a cooling rate less than 1° C. per minute.

In one embodiment, the method further comprises:
a second cooling step, preferably a uniform cooling, adapted to cooling the second mixture to a third temperature lower than the second temperature; the second cooling step being adapted to precipitate a second part of the lithium hydride having a second lithium isotope; and
a second separation step adapted to separating the precipitated second part of the lithium hydride from the second mixture, forming a third mixture; and
a second extraction step adapted to extracting the separated second part of the lithium hydride, after or during the second separation step.

In one embodiment, the second cooling step is slow, for example has a cooling rate less than 1° C. per minute.

In one embodiment, providing the first mixture comprises a heating step adapted to heating the first mixture to the first temperature.

In one embodiment, the method comprises repeating the providing step, and repeating:
the first cooling and separation steps, at least part of the second mixture being used as the first mixture; and/or
the second cooling and separation steps, at least part of the third mixture being used as the first mixture.

In one embodiment, the method comprises repeating the providing step, and repeating:
the first cooling, separation and extraction steps, at least part of the second mixture being used as the first mixture; and/or
the second cooling, separation and extraction steps, at least part of the third mixture being used as the first mixture.

In one embodiment, the first isotope is the ⁷Li isotope and the second isotope is the ⁶Li isotope.

In one embodiment:
the first temperature is greater than 410° C., for example greater than 500° C.;
the second temperature is lower than, or equal to, 410° C., for example comprised between 390° C. and 410° C., for example equal to about 400° C.; and/or
the third temperature is lower than, or equal to, 408° C., for example comprised between 388° C. and 408° C., for example equal to about 398° C.

In one embodiment, at least one of the first and second separation steps comprises spinning the first and/or the second mixture, for example spinning a chamber containing said first and/or second mixture.

In one embodiment, the first and second temperatures are determined according to the lithium hydride concentration in the first mixture.

In one embodiment, the third temperature is determined according to the lithium hydride concentration in the first mixture.

In one embodiment, the first and second temperatures are determined using a Li/LiH phase diagram.

In one embodiment, the third temperature is determined using a Li/LiH phase diagram.

In one embodiment, the molar concentration of lithium hydride in the first mixture is comprised between 2 and 95%, for example between 2,5% and 95%.

In one embodiment, each of the second temperature and the third temperature is greater than 200° C., for example greater than 210° C.

One embodiment provides a device adapted to implement the method according to an embodiment, wherein the device comprises:
a chamber adapted to contain a mixture comprising at least lithium and lithium hydride; and
a cooling mechanism adapted to cooling the mixture in the chamber.

In one embodiment, the cooling mechanism comprises a cooling jacket covering at least partially the chamber and means adapted to transport a coolant in the cooling jacket.

In one embodiment, the device further comprises a heating apparatus adapted to heating the mixture in the chamber, for example an ohmic heating or an inductive heating apparatus.

In one embodiment, the device further comprises rotating means adapted to spin the chamber, for example a shaft coupled to the chamber and to a motor located outside the chamber.

In one embodiment, the chamber is shaped in a way that allows for liquid or solid contents that accumulate at the bottom of said chamber to be discharged, for example a shape of a bell, an inverted bell or a diamond.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 is a diagram describing the method for the isotopic separation of lithium.

FIG. 2 is frontal view of a device that executes the method for the isotopic separation of lithium.

FIG. 3 is a Li/LiH phase diagram according to LiH molar concentration.

FIG. 4 is another Li/LiH phase diagram according to LiH molar concentration.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

The figures are not to scale. It should be noted that the drawings refer to an embodiment of the disclosed method and device for isotopic separation of lithium, sometimes also referred simply as device or method, accordingly. Other embodiments may be possible, as someone with appropriate training may readily appreciate. The actual dimension and/or shape of each of the components of the embodiment may vary. Only important details of the embodiment are shown, however one of ordinary skill in the art can appreciate how the overall device be constructed, may without undue experimentation. Similarly, a person of ordinary skill may anticipate that steps of the method may be executed in a different order, according to the specific needs of the use. Some details have been omitted from the drawings, but the inventors believe that adding these details is unnecessary for the overall appreciation of the characteristics of the invention disclosed. These omitted details include, among others, elements for holding or fixing the device or its functional components. Some characteristics of the embodiment appear exaggerated to facilitate understanding. The embodiments disclosed, and alternatives observed should not be considered as limiting the invention in any way.

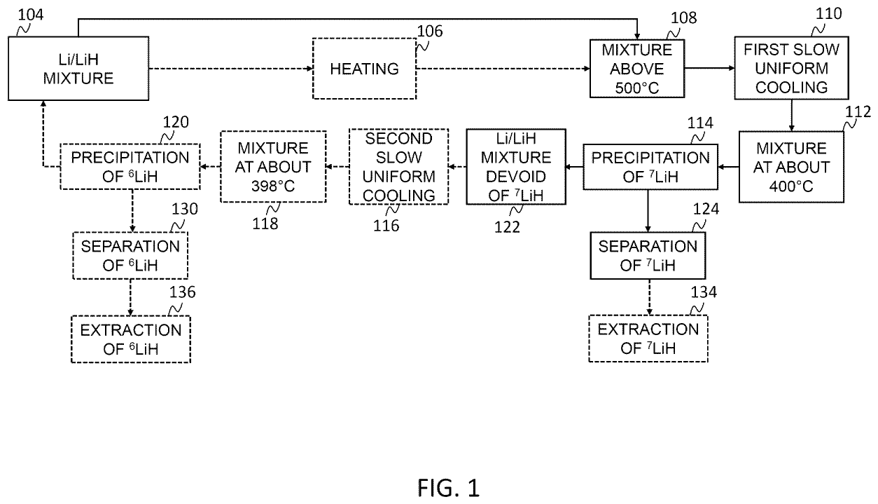

A diagram of an embodiment of a method for the isotopic separation of lithium is shown in FIG. 1.

In this embodiment, the Li/LiH mixture 104 (first mixture) undergoes heating 106 step. After being heated, the Li/LiH mixture 104 is at a first temperature, for example above about 500° C., in the mixture above 500° C. 108 step. Afterwards there is a first slow uniform cooling 110 step. The Li/LiH mixture 104 is then cooled, until the mixture reaches a second temperature, for example of about 400° C., in the mixture at about 400° C. 112 step. This step leads to the precipitation of a first lithium isotope as part of an hydrogen compound ⁷LiH, this step may be called precipitation of ⁷LiH 114. At this point, the process may be divided into two branches. The first branch leads to the separation of ⁷LiH from the rest of the Li/LiH mixture 104 in the separation of ⁷LiH 124 step. The rest of the Li/LiH mixture 104 (devoid of ⁷LiH) may be called the second Li/LiH mixture devoid of ⁷LiH 122. After ⁷LiH is distinctively separated, it may then be extracted in the extraction of ⁷LiH 134 step. The second branch deals with cooling the second Li/LiH mixture 122 in a second slow uniform cooling 116 step. The second Li/LiH mixture 122 is cooled until the mixture reaches a third temperature in the mixture, for example at about 398° C., in the mixture at about 398° C. 118 step. At this temperature, precipitation of another lithium isotope initiates, as part of the hydrogen compound ⁶LiH. This stage is called precipitation of ⁶LiH 120. Once again, at this stage, two different branches may be followed. In a first branch, the isotope is separated in the separation of ⁶LiH 130 step. Once the isotope is separated, it can then be extracted in the extraction of ⁶LiH 136 step. The second branch is the reformation of the Li/LiH mixture 104, and the process may be restarted, or the formation of a third Li/LiH mixture obtained in the second branch after precipitation of ⁶LiH 120 can serve as the first mixture in repetition of the process.

Alternatively, the process can be restarted after the precipitation of ⁷LiH 114 and after obtaining the second Li/LiH mixture 122, but without proceeding with the branch that deals with its second cooling and leads to precipitation of ⁶LiH 120.

When reference is made to a uniform cooling (or uniformly cooled), this is directed to a cooling which is substantially uniform in the whole volume of the mixture, and when reference is made to a slow cooling, this is directed to the cooling rate, which is for example less than 1° C. per minute.

The temperatures indicated in the diagram of FIG. 1 are indicative temperatures and may depend on the concentration of the lithium hydride in the mixture.

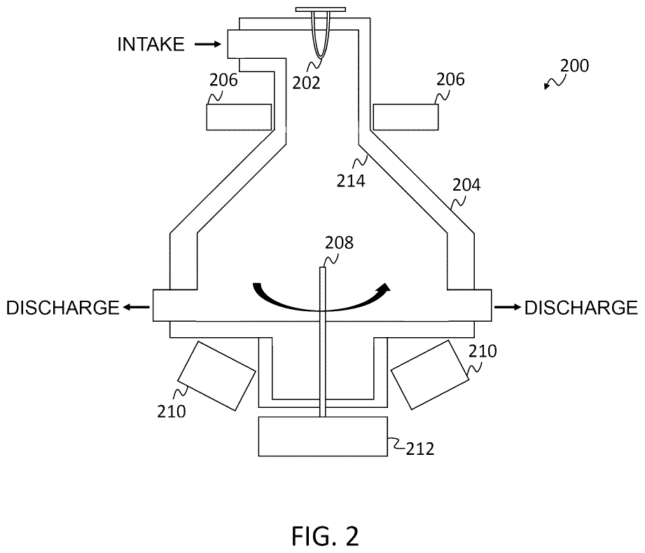

An embodiment of a device that may reproduce the method from FIG. 1 is shown in FIG. 2. The device of FIG. 2 is comprised of a chamber 214, the chamber 214 having an intake on top and a discharge on bottom. The device has heating means, which may be described as a coil 202 for ohmic heating, but may also be another kind of heating mechanism like an inductive heating coil. In order to center the device, centering magnets 206 may be positioned near the top of the device. The device may also be lifted for which lifting magnets 210 may also be fashioned. A motor 212 may be coupled, for example connected, to a shaft 208. The shaft 208 may be coupled, for example connected, to the chamber 214, so that the chamber 214 may spin. The device may be covered by a cooling jacket 204. The cooling jacket 204 may include means for transporting a coolant so that it may cool the interior of the chamber 214.

### EXAMPLE OF OPERATION

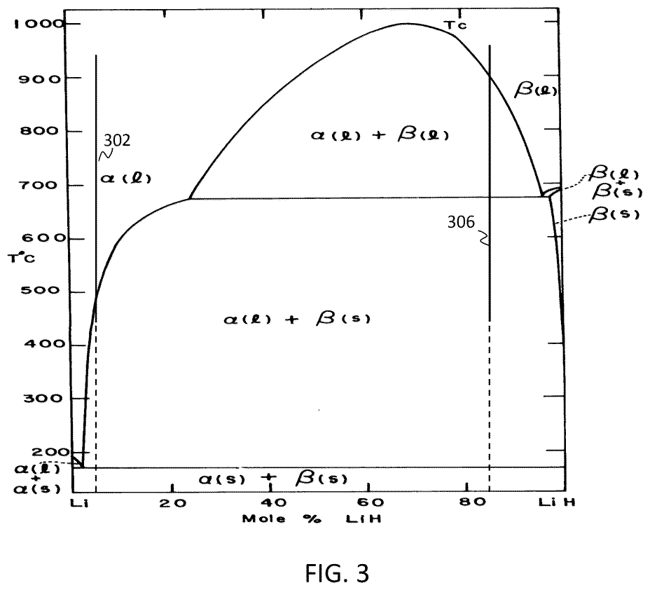

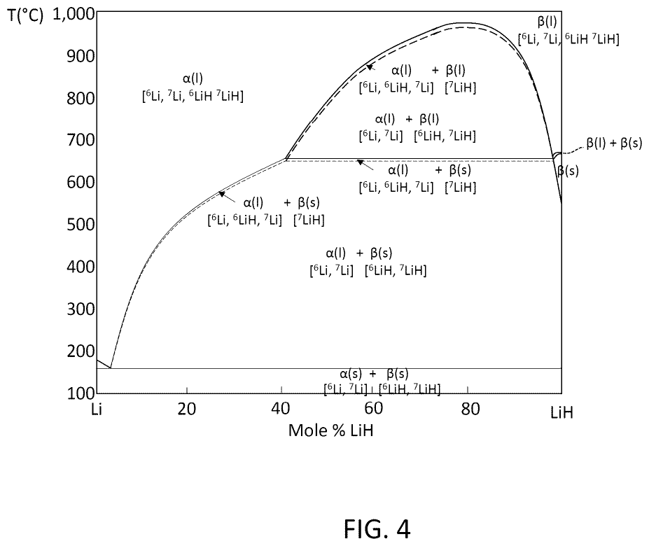

The method described in the diagram in FIG. 1 may be accommodated to work with mixtures comprising lithium and lithium hydrides in different molal compositions according to the phase diagrams in FIG. 3 and FIG. 4. The abscissa of FIG. 3 and FIG. 4 represents the LiH molar concentration in the Li/LiH mixture.

The mixtures comprising lithium and lithium hydrides may also comprise lithium deuteride and/or lithium tritide.

Two trajectories are identified in FIG. 3 as examples meaningful for the operation of this method. It should be understood that these two trajectories are not limiting, and that other trajectory lines with different LiH molar concentrations may also be used. A person of ordinary skill in the art should be able to determine the best molal composition according to the needs of a specific use of the method.

A first trajectory 302 may start with the Li/LiH mixture 104 from FIG. 1 at a LiH molar composition of about 5% and a temperature equal to, or higher than, about 500° C. in an alfa liquid phase α(l). When the Li/LiH mixture 104 is cooled below about 500° C., it separates into a liquid, alfa phase α(l) and a solid, beta phase β(s).

A second trajectory 306 may start with the Li/LiH mixture 104 at about 85% LiH molar composition and at a temperature higher than about 900° C. As the Li/LiH mixture 104 is cooled, it splits into two distinctive liquid phases, alfa and beta α(l)+β(l). When the Li/LiH mixture is cooled further, the beta phase solidifies in a beta solid phase β(s).

As can be seen in FIG. 4, in the alfa liquid and beta solid phases α(l)+β(s), the alfa phase α(l) is rich in Li (⁶Li, ⁷Li), and may also be rich in ⁶LiH above the precipitation temperature for ⁶LiH, in particular if the cooling is uniform and stopped at the precipitation temperature for ⁷LiH, without reaching the precipitation temperature for ⁶LiH, and the solid beta phase β(s) is rich in LiH, and may be more specifically rich in ⁷LiH above the precipitation temperature for ⁶LiH, in particular if the cooling is uniform and stopped at the precipitation temperature for ⁷LiH, without reaching the precipitation temperature for ⁶LiH.

Therefore, it is possible to separate the ⁶LiH and ⁷LiH isotopes using a transition temperature which depends on the LiH molar concentration. Depending on the LiH molar concentration, the precipitation temperature for ⁶LiH may differ from the precipitation temperature for ⁷LiH of a few degrees. The precipitation temperature for ⁶LiH may be lower than the precipitation temperature for ⁷LiH. For example, the difference between the ⁷LiH precipitation temperature and the ⁶LiH precipitation temperature may be comprised between 1 and 5° C., or even between 2 and 4° C., this difference being enough to operate the isotope separation.

It is well-known in chemistry that molecules experience an “isotopic effect”, that is, a slight difference in behavior, depending on the particular isotope used for each atom. This is a universal effect, that can be explained by the fact that atoms of different isotopes interact with one another with nearly identical forces, but have different masses. This effect can explain that the phase diagram of a Li/LiH system varies according to the specific H isotope, which can be H, D (deuterium) or even T (tritium). Namely, the transition temperatures from one phase to another, or from one phase to two distinctive phases, are slightly different, for example of a few degrees, depending on the H isotope in the Li/LiH system, as described for example in “Applied Chemistry of the Alkali Metals” by Hans U. Borgostedt and Cherian K. Mathews, at pages 136-140.

Still due to different isotopic masses, the phase diagram of a Li/LiH system is expected to vary according to the specific Li isotope, and slightly different transition temperatures are expected depending on the Li isotope in the Li/LiH system. As illustrated in FIG. 4, these temperature differences are expected to be of the same order of magnitude than for H isotopes in the Li/LiH system, for example of a few degrees, because the difference in mass between ⁶Li and ⁷Li is the same as between H and D (one neutron).

Hence, these differences between isotopes ⁶LiH and ⁷LiH allow to selectively precipitate ⁶LiH or ⁷LiH from a ⁶Li/⁷Li/⁶LiH/⁷LiH solution.

FIG. 3 and FIG. 4 further show that, for any LiH molar concentration in a Li/LiH mixture, for example between 2% and 95% molar concentration, the transition temperature which is adapted to operate the separation between the isotopes of LiH can be determined using a Li/LiH phase diagram, for example the Li/LiH phase diagram of FIG. 3 or FIG. 4.

A first embodiment of the device 200 for the isotopic separation of lithium shown in FIG. 2 may execute the steps of the method from FIG. 1, in the following manner. The Li/LiH mixture 104 is deposited into the device chamber 214 from the intake at the top of the device. The Li/LiH mixture 104 may then be heated through the heating coil 202. Once the Li/LiH mixture 104 is in the mixture above about 500° C. 108 step, the cooling jacket 204 may be used to cool down the Li/LiH mixture 104 during the first slow uniform cooling 110 or the second slow uniform cooling 116 steps. For the separation of the isotopes, the chamber 214 may spin. As the chamber 214 is coupled to the motor 212 by means of the shaft 208, when the motor 212 operates, the chamber 214 spins. The spinning of the chamber 214 may be used to cause separation of the Li/LiH mixture 104, using effects like density difference, into the constituent phases, alfa and beta, of the Li/LiH mixture 104. In other words, beta phase, which is for example richer in ⁷LiH and/or in ⁶LiH, is denser and thus accumulates at outer radii, when subject to centrifugal forces. This embodiment of the device is shaped in a way that allows for the liquid or solid contents of the chamber 214 that accumulate at the bottom to be discharged. This function of the shape may be achieved through other means or through different shapes. For instance, in another embodiment the shape could be described as a bell, an inverted bell, a diamond, or some other shape that allows for accumulation of solid or liquid material at the bottom.

Other devices may be used to execute the steps of the method according to the embodiments. Another example of device is given in European patent application number EP22305438,filed on Apr. 4, 2022 by the same applicant “RENAISSANCE FUSION”, entitled “DEVICE AND METHOD FOR EXTRACTION OF LITHIUM HYDRIDES”, which is hereby incorporated by reference to the maximum extent allowable by law. In addition, the method, or at least some of the steps of the method, described in the above-mentioned application may be used to separate lithium from lithium hydride, after the isotopic separation of lithium.

Example embodiments of the invention are summarized here. Other embodiments can also be understood from the entirety of the specification as well as the claims filed herein.

Example 1. A method for isotopic separation of lithium, the method comprising:
providing a first mixture (104) comprising at least lithium, lithium hydride, and possibly lithium deuteride and/or lithium tritide, the first mixture being at a first temperature;
a first cooling step (110), preferably a uniform cooling, adapted to cooling the first mixture to a second temperature lower than the first temperature; the first cooling step being adapted to precipitating a first part of the lithium hydride having a first lithium isotope;
a first separation step (124) adapted to separating the precipitated first part of the lithium hydride from the first mixture, forming a second mixture (122).

Example 2. The method according to example 1, wherein the method further comprises a first extraction step (134) adapted to extracting the precipitated first part of the lithium hydride, after or during the first separation step (124).

Example 3. The method according to example 1 or 2, wherein the method further comprises:
a second cooling step (116), preferably a uniform cooling, adapted to cooling the second mixture (122) to a third temperature lower than the second temperature; the second cooling step being adapted to precipitate a second part of the lithium hydride having the second lithium isotope; and
a second separation step (130) adapted to separating the precipitated second part of the lithium hydride from the second mixture, forming a third mixture.

Example 4. The method according to example 3, wherein the method further comprises a second extraction step (136) adapted to extracting the precipitated second part of the lithium hydride, after or during the second separation step (130).

Example 5. The method according to any one of examples 1 to 4, wherein the first and/or the second cooling step is slow, for example has a cooling rate less than 1° C. per minute.

Example 6. The method according to any one of examples 1 to 5, wherein providing the first mixture (104) comprises a heating step (106) adapted to heating the first mixture to the first temperature.

Example 7. The method according to any one of examples 1 to 6, wherein the method comprises repeating the providing step and repeating:
the first cooling and separating steps, at least part of the second mixture being used as the first mixture; and/or
the second cooling and separating steps, at least part of the third mixture being used as the first mixture.

Example 8. The method according to any one of examples 1 to 7, wherein the first isotope is the ⁷Li isotope and the second isotope is the ⁶Li isotope.

Example 9. The method according to any one of examples 1 to 8, wherein:
the first temperature is above about 410° C., for example above about 500° C.;
the second temperature is comprised between 390° C. and 410° C., for example equal to about 400° C.; and/or
the third temperature is comprised between 388° C. and 408° C., for example equal to about 398° C.

Example 10. The method according to any one of examples 1 to 9, wherein at least one of the first and second separating steps comprises spinning the first and/or the second mixture, for example spinning a chamber (214) containing said mixture.

Example 11. A device (200) adapted to implement the method of any one of examples 1 to 10, wherein the device comprises:
a chamber (214) adapted to contain a mixture (104) comprising at least lithium and lithium hydride; and
a cooling mechanism adapted to cooling the mixture in the chamber.

Example 12. The device according to example 11,wherein the chamber (214) comprises an intake on a top portion and a discharge on a bottom portion.

Example 13. The device according to example 11 or 12, wherein the cooling mechanism comprises a cooling jacket (204) covering at least partially the chamber and means adapted to transport a coolant in the cooling jacket.

Example 14. The device according to any one of examples 11 to 13, further comprising a heating apparatus (202) adapted to heating the mixture in the chamber, for example an ohmic heating or an inductive heating apparatus.

Example 15. The device according to any one of examples 11 to 14, further comprising rotating means adapted to spin the chamber, for example a shaft (208) coupled to the chamber and to a motor (212) located outside the chamber.

Example 16. The device according to any one of examples 11 to 15, wherein the chamber (214) is shaped in a way that allows for liquid or solid contents that accumulate at the bottom of said chamber to be discharged, for example a shape of a bell, an inverted bell or a diamond.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

### LIST OF ACRONYMS

⁶Li: Lithium-6
⁷Li: Lithium-7
COLEX: Column exchange
OREX: Organic exchange
ELEX: Electro-exchange
LiOH: Lithium hydroxide
LiCl: Lithium chloride
DEMO: DEMOnstration Power Plant
LiH: Lithium hydride
Li: Lithium
LiH: Lithium-7 hydride
LiH: Lithium-6 hydride

1. A method for isotopic separation of lithium, the method comprising:
providing a first mixture comprising at least lithium, lithium hydride, the first mixture being at a first temperature;
a first cooling step, preferably a uniform cooling, adapted to cooling the first mixture to a second temperature lower than the first temperature; the first cooling step being adapted to precipitating a first part of the lithium hydride having a first lithium isotope;
a first separation step adapted to separating the precipitated first part of the lithium hydride from the first mixture, forming a second mixture; and
a first extraction step adapted to extracting the separated first part of the lithium hydride, after or during the first separation step.

2. The method according to claim 1, wherein the first cooling step is slow, for example has a cooling rate less than 1° C. per minute.

3. The method according to claim 1, wherein the method further comprises:
a second cooling step, preferably a uniform cooling, adapted to cooling the second mixture to a third temperature lower than the second temperature; the second cooling step being adapted to precipitate a second part of the lithium hydride having a second lithium isotope; and
a second separation step adapted to separating the precipitated second part of the lithium hydride from the second mixture, forming a third mixture; and
a second extraction step adapted to extracting the separated second part of the lithium hydride, after or during the second separation step.

4. The method according to claim 3, wherein the second cooling step is slow, for example has a cooling rate less than 1° C. per minute.

5. The method according to claim 1, wherein providing the first mixture comprises a heating step adapted to heating the first mixture to the first temperature.

6. The method according to claim 1, wherein the method comprises repeating the providing step and repeating:
the first cooling and separation steps, at least part of the second mixture being used as the first mixture; and/or
the second cooling and separation steps, at least part of the third mixture being used as the first mixture.

7. The method according to claim 1, wherein the first isotope is the 7Li isotope and the second isotope is the 6Li isotope.

8. The method according to claim 1, wherein:
the first temperature is greater than 410° C., for example greater than 500° C.;
the second temperature is lower than, or equal to, 410° C., for example comprised between 390° C. and 410° C., for example equal to about 400° C.; and/or
the third temperature is lower than, or equal to, 408° C., for example comprised between 388° C. and 408° C., for example equal to about 398° C.

9. The method according to claim 1, wherein at least one of the first and second separation steps comprises spinning the first and/or the second mixture, for example spinning a chamber containing said first and/or second mixture.

10. The method according to claim 1, wherein the first and second temperatures, and for example the third temperature, are determined according to the lithium hydride concentration in the first mixture.

11. The method according to claim 1, wherein the first and second temperatures, and for example the third temperature, are determined using a Li/LiH phase diagram.

12. The method according to claim 1, wherein the molar concentration of lithium hydride in the first mixture is comprised between 2 and 95%, for example between 2,5% and 95%.

13. The method according to claim 1, wherein each of the second temperature and the third temperature is greater than 200° C., for example greater than 210° C.

14. A device adapted to implement the method of claim 1, wherein the device comprises:
a chamber adapted to contain a mixture comprising at least lithium and lithium hydride; and
a cooling mechanism adapted to cooling the mixture in the chamber.

15. The device according to claim 14, wherein the cooling mechanism comprises a cooling jacket covering at least partially the chamber and means adapted to transport a coolant in the cooling jacket.

16. The device according to claim 14, further comprising a heating apparatus adapted to heating the mixture in the chamber, for example an ohmic heating or an inductive heating apparatus.

17. The device according to claim 14, further comprising rotating means adapted to spin the chamber, for example a shaft coupled to the chamber and to a motor located outside the chamber.

18. The device according to claim 14, wherein the chamber is shaped in a way that allows for liquid or solid contents that accumulate at the bottom of said chamber to be discharged, for example a shape of a bell, an inverted bell or a diamond.
